(19) United States
(12) Patent Application Publication
(10) Pub. No.: US 2008/0182520 A1
(43) Pub. Date: Jul. 31, 2008

(54) Remote low noise amplifier for a reception system and communication device and methods for use therewith

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/700,806

(22) Filed: Jan. 30, 2007

(51) Int. Cl. H04B 15/00

(52) U.S. Cl. 455/63.1

(57) ABSTRACT

A reception system includes an antenna that receives and inbound RF signal. An antenna interface includes a low noise amplifier that generates an amplified received signal, based on the inbound RF signal. A transmission path coupled carries the amplified received signal to an integrated circuit, that includes a RF receiver with an RF front end that generates a desired RF signal from the amplified received signal, a down conversion module, that generates a down converted signal from the desired RF signal and a receiver processing module that generates inbound data for at least one communication application.

### BACKGROUND OF THE INVENTION

1. Technical Field of the Invention

This invention relates generally to mobile communication devices and more particularly to a circuit for reducing noise in a combined voice, data and RF integrated circuit.

2. Description of Related Art

As is known, integrated circuits are used in a wide variety of products including, but certainly not limited to, portable electronic devices, computers, computer networking equipment, home entertainment, automotive controls and features, and home appliances. As is also known, integrated circuits include a plurality of circuits in a very small space to perform one or more fixed or programmable functions.

Noise rejection can be an important consideration for electronic devices, particularly for mobile devices with RF receivers that operate from low-power received signals. In many implementations, the transceiver can be located some distance from the antenna. The transmission path between the antenna and the RF receiver can couple unwanted noise into the receiver front end.

The advantages of the present invention will be apparent to one skilled in the art when presented with the disclosure herein.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of an embodiment of a communication system in accordance with the present invention;

FIG. 2 is a schematic block diagram of an embodiment of another communication system in accordance with the present invention;

FIG. 3 is a schematic block diagram of an embodiment of an integrated circuit in accordance with the present invention;

FIG. 4 is a schematic block diagram of another embodiment of an integrated circuit in accordance with the present invention;

FIG. 5 is a schematic block diagram of an embodiment of an RF transceiver in accordance with the present invention;

FIG. 6 is a schematic block diagram of an embodiment of an antenna interface in accordance with the present invention;

FIG. 7 is a schematic block diagram of another embodiment of an antenna interface in accordance with the present invention;

FIG. 8 is a flow chart of an embodiment of a method in accordance with the present invention;

FIG. 9 is a flow chart of an embodiment of a method in accordance with the present invention;

FIG. 10 is a flow chart of an embodiment of a method in accordance with the present invention;

FIG. 11 is a flow chart of an embodiment of a method in accordance with the present invention; and

FIG. 12 is a flow chart of an embodiment of a method in accordance with the present invention.

### DETAILED DESCRIPTION OF THE INVENTION

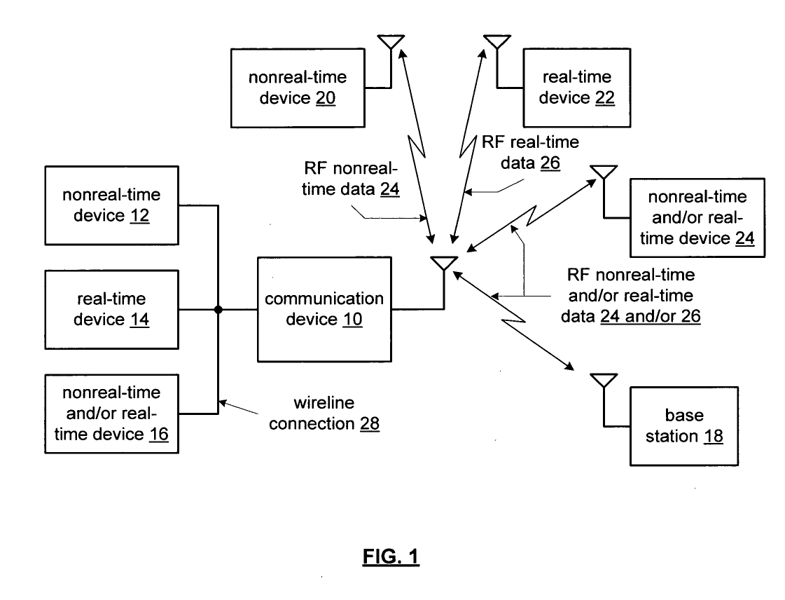

FIG. 1 is a schematic block diagram of an embodiment of a communication system in accordance with the present invention. In particular a communication system is shown that includes a communication device 10 that communicates real-time data 24 and non-real-time data 26 wirelessly with one or more other devices such as base station 18, non-real-time device 20, real-time device 22, and non-real-time and/or real-time device 24. In addition, communication device 10 can also optionally communicate over a wireline connection with non-real-time device 12, real-time device 14 and non-real-time and/or real-time device 16.

In an embodiment of the present invention the wireline connection 28 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device 10.

Communication device 10 can be a mobile phone such as a cellular telephone, a personal digital assistant, game console, personal computer, laptop computer, or other device that performs one or more functions that include communication of voice and/or data via wireline connection 28 and/or the wireless communication path. In an embodiment of the present invention, the real-time and non-real-time devices 12, 14 16, 18, 20, 22 and 24 can be personal computers, laptops, PDAs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 26 includes voice, audio, video and multimedia applications including Internet gaming, etc. The non-real-time data 24 includes text messaging, email, web browsing, file uploading and downloading, etc.

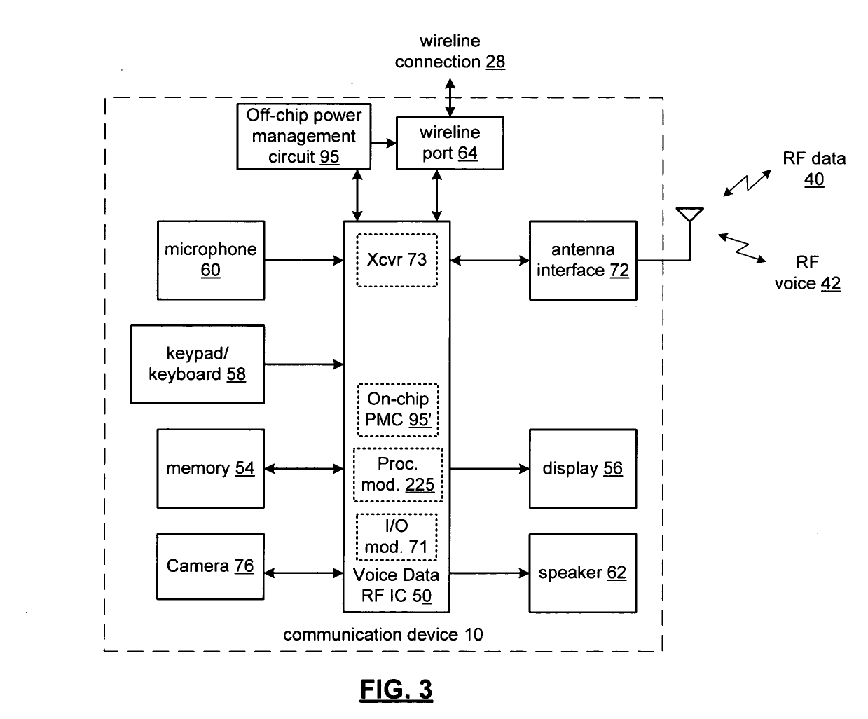

In an embodiment of the present invention, the communication device 10 includes an integrated circuit, such as a combined voice, data and RF integrated circuit that includes one or more features or functions of the present invention. Such integrated circuits shall be described in greater detail in association with FIGS. 3-12 that follow.

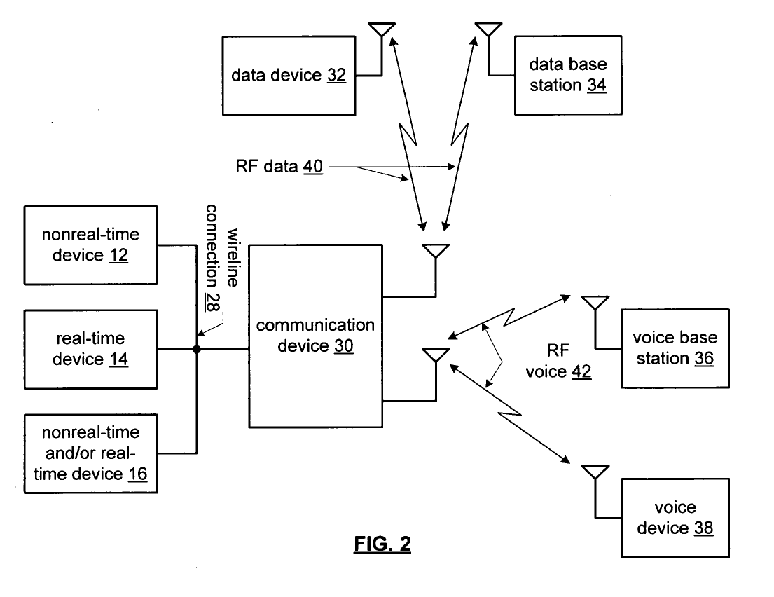

FIG. 2 is a schematic block diagram of an embodiment of another communication system in accordance with the present invention. In particular, FIG. 2 presents a communication system that includes many common elements of FIG. 1 that are referred to by common reference numerals. Communication device 30 is similar to communication device 10 and is capable of any of the applications, functions and features attributed to communication device 10, as discussed in conjunction with FIG. 1. However, communication device 30 includes two separate wireless transceivers for communicating, contemporaneously, via two or more wireless communication protocols with data device 32 and/or data base station 34 via RF data 40 and voice base station 36 and/or voice device 38 via RF voice signals 42.

FIG. 3 is a schematic block diagram of an embodiment of an integrated circuit in accordance with the present invention. In particular, a voice data RF integrated circuit (IC) 50 is shown that implements communication device 10 in conjunction with microphone 60, keypad/keyboard 58, memory 54, speaker 62, display 56, camera 76, antenna interface 52 and wireline port 64. In addition, voice data RF IC 50 includes a transceiver 73 with RF and baseband modules for formatting and modulating data into RF real-time data 26 and non-real-time data 24 and transmitting this data via an antenna interface 72 and an antenna. Further, voice data RF IC 50 includes an input/output module 71 with appropriate encoders and decoders for communicating via the wireline connection 28 via wireline port 64, an optional memory interface for communicating with off-chip memory 54, a codec for encoding voice signals from microphone 60 into digital voice signals, a keypad/keyboard interface for generating data from keypad/keyboard 58 in response to the actions of a user, a display driver for driving display 56, such as by rendering a color video signal, text, graphics, or other display data, and an audio driver such as an audio amplifier for driving speaker 62 and one or more other interfaces, such as for interfacing with the camera 76 or the other peripheral devices.

Off-chip power management circuit 95 includes one or more DC-DC converters, voltage regulators, current regulators or other power supplies for supplying the voice data RF IC 50 and optionally the other components of communication device 10 and/or its peripheral devices with supply voltages and or currents (collectively power supply signals) that may be required to power these devices. Off-chip power management circuit 95 can operate from one or more batteries, line power and/or from other power sources, not shown. In particular, off-chip power management module can selectively supply power supply signals of different voltages, currents or current limits or with adjustable voltages, currents or current limits in response to power mode signals received from the voice data RF IC 50. Voice Data RF IC 50 optionally includes an on-chip power management circuit 95′ for replacing the off-chip power management circuit 95.

In an embodiment of the present invention, the voice data RF IC 50 is a system on a chip integrated circuit that includes at least one processing device. Such a processing device, for instance, processing module 225, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the Voice Data RF IC 50 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

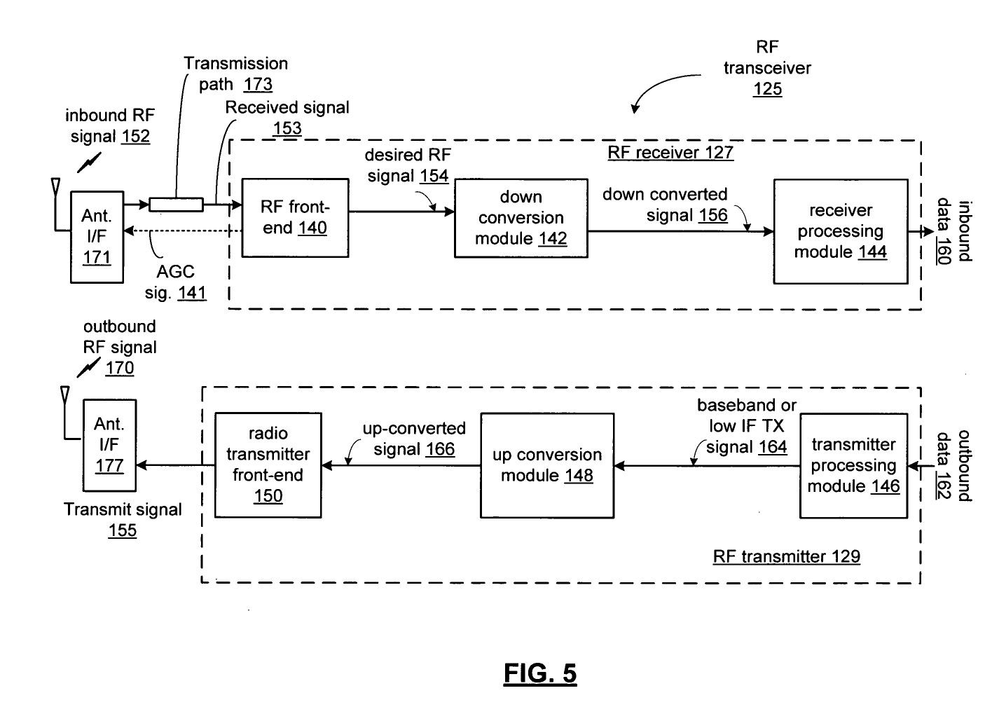

In operation, the voice data RF IC 50 executes operational instructions that implement one or more of the applications (real-time or non-real-time) attributed to communication devices 10 and 30 as discussed in conjunction with FIGS. 1 and 2. Further, RF IC 50 includes a remote low noise amplifier in accordance with the present invention that will be discussed in greater detail in association with FIG. 5.

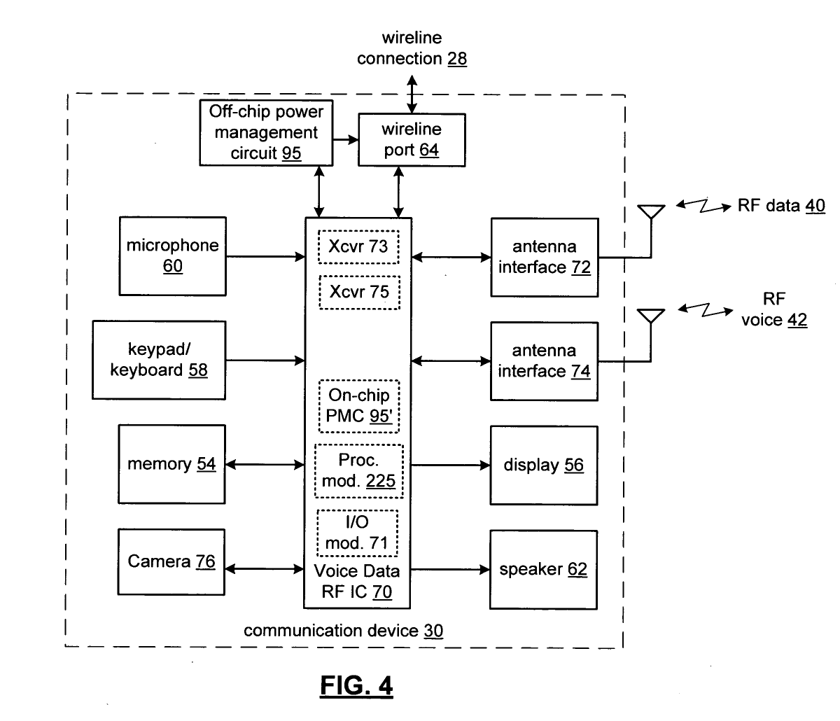

FIG. 4 is a schematic block diagram of another embodiment of an integrated circuit in accordance with the present invention. In particular, FIG. 4 presents a communication device 30 that includes many common elements of FIG. 3 that are referred to by common reference numerals. Voice data RF IC 70 is similar to voice data RF IC 50 and is capable of any of the applications, functions and features attributed to voice data RF IC 50 as discussed in conjunction with FIG. 3. However, voice data RF IC 70 includes two separate wireless transceivers 73 and 75 for communicating, contemporaneously, via two or more wireless communication protocols via RF data 40 and RF voice signals 42.

In operation, the voice data RF IC 70 executes operational instructions that implement one or more of the applications (real-time or non-real-time) attributed to communication device 10 as discussed in conjunction with FIG. 1. Further, RF IC 70 includes a remote low noise amplifier in accordance with the present invention that will be discussed in greater detail in association with FIG. 5.

FIG. 5 is a schematic block diagram of an RF transceiver 125, such as transceiver 73 or 75, which may be incorporated in communication devices 10 and/or 30. The RF transceiver 125 includes an RF transmitter 129, and RF receiver 127. The RF receiver 127 includes a RF front end 140, a down conversion module 142, and a receiver processing module 144. The RF transmitter 129 includes a transmitter processing module 146, an up conversion module 148, and a radio transmitter front-end 150.

As shown, RF transmitter 129 is coupled to another antenna a diplexer (duplexer) 177 that produces outbound RF signal 170 in response to transmit signal 155. RF receiver 127 is coupled to an antenna through an off-chip antenna interface 171, such as antenna interface 72, that produces amplified received signal 153 from inbound RF signal 152 to be carried by transmission path 173 to RF-front end 140. Antenna interface 171 includes a low noise amplifier that generates the amplified received signal 153 based on the inbound RF signal 152 received by the antenna. Including the low noise amplifier in the antenna interface 171, remote from the integrated circuit used to implement RF receiver 127, and in particular, before the transmission path that couples the antenna interface to the RF front-end 140, reduces the impact of noise and/or interference that may be induced on the transmission path 173, by the path itself or from external noise and/or interference sources.

This low noise amplifier has a gain that is optionally based an automatic gain control signal 141 that is received by the antenna interface 171 from the RF receiver 127, such as from the RF front-end 140 or generated locally by additional receiver circuitry in antenna interface 171. The automatic gain control signal can be generated based on an indication of the received signal strength, signal to noise ratio, or based on other receiver parameters generated by RF receiver 127 or antenna interface 171 as will be apparent to one skilled in the art when presented the disclosure herein. The automatic gain control signal 141 can be a slowly varying analog signal, or other low frequency signal, either analog or digital that provides feedback to the low noise amplifier of antenna interface 171 to adjust its gain based on one or more parameters of the amplifier received signal 153 as received and processed by RF receiver 127.

In an embodiment of the present invention, the automatic gain control signal 141 can be carried by the transmission path 173. For instance, the low noise amplifier and RF front-end 140 can be alternating current (AC) coupled to the transmission path and the automatic gain control signal 141 can be introduced on the transmission path by the RF receiver 127 as a direct current (DC) component. Other configurations can be used such as coupling the automatic gain control signal 141 to the transmission path 173 in low frequency portions of the spectrum that are unused by the amplified received signal 153. In an alternative embodiment, one or more separate conductors can be used to couple the automatic gain control signal 141 from the RF receiver 127 to the low noise amplifier of antenna interface 171.

While separate antennas are represented for transmission and reception, the RF receiver 127 and RF transmitter 129 can be configured to share a single antenna with a single antenna interface, such as antenna interface 171, such as with the incorporation of a transmit/receive switch or a diplexor (duplexer) into antenna interface 171. The use of a diplexor in this regard will be discussed further inconjunction with FIG. 7.

Further, while each antanna is represented by a single element, each antenna may be fixed, programmable, an antenna array, part of a multi-input multi-output MIMO antenna structure or other antenna configuration. Accordingly, the antenna structure of the wireless transceiver can also depend on the particular standard(s) to which the wireless transceiver is compliant and the applications thereof.

In operation, the transmitter receives outbound data 162 from a host device or other source via the transmitter processing module 146. The transmitter processing module 146 processes the outbound data 162 in accordance with a particular wireless communication standard (e.g., IEEE 802.11, Bluetooth, RFID, GSM, CDMA, et cetera) to produce baseband or low intermediate frequency (IF) transmit (TX) signals 164. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 includes, but is not limited to, scrambling, encoding, puncturing, mapping, modulation, and/or digital baseband to IF conversion. Further note that the transmitter processing module 146 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 146 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up converted signals 166 based on a transmitter local oscillation 168.

The radio transmitter front end 150 includes a power amplifier and may also include a transmit filter module. The power amplifier amplifies the up converted signals 166 to produce outbound RF signals 170, which may be filtered by the transmitter filter module, if included. The antenna structure transmits the outbound RF signals 170 to a targeted device such as a RF tag, base station, an access point and/or another wireless communication device via an antenna interface 171 coupled to an antenna that provides impedance matching and optional bandpass filtration.

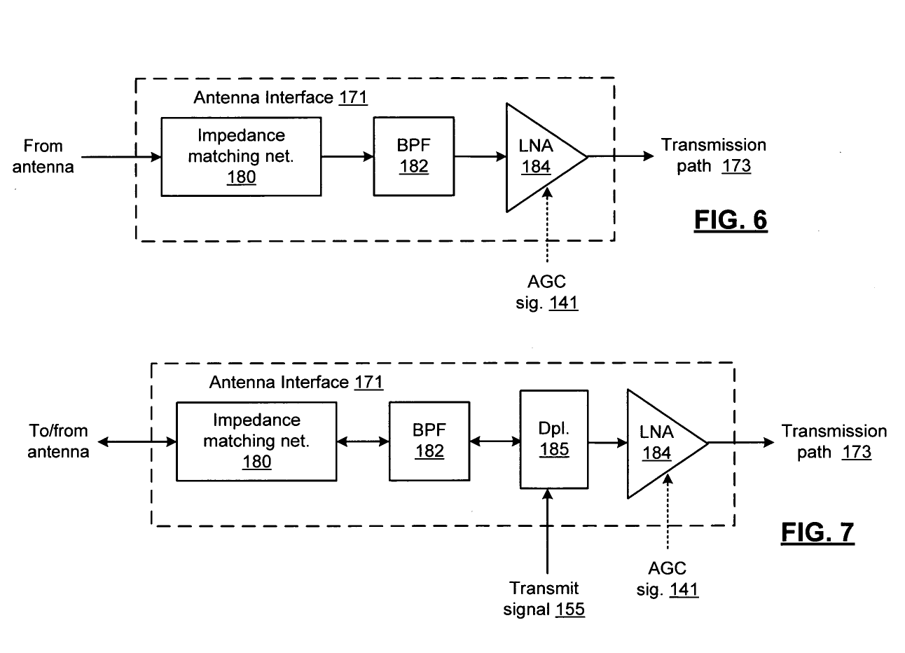

The receiver receives inbound RF signals 152 via the antenna and off-chip antenna interface 171 that operates to process the inbound RF signal 152 into amplified received signal 153 for the receiver front-end 140. In addition to the amplification provided by the low noise amplifier previously described, antenna interface 171 optionally provides impedance matching of antenna to the RF front-end 140 and optional bandpass filtration of the inbound RF signal 152, as will be described in greater detail in conjunction with FIG. 6. Receiver front-end 140 produces a desired RF signal 154 corresponding to the frequency channel or channels of interest or potential interest by means of further amplification, mixing, filtration, and or other signal processing or by merely coupling the amplified received signal 153 as the desired RF signal 154.

The down conversion module 70 includes a mixing section, an analog to digital conversion (ADC) module, and may also include a filtering and/or gain module. The mixing section converts the desired RF signal 154 into a down converted signal 156 that is based on a receiver local oscillation 158, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156. Note that the ordering of the ADC module and filtering and/or gain module may be switched, such that the filtering and/or gain module is an analog module.

The receiver processing module 144 processes the baseband or low IF signal 156 in accordance with a particular wireless communication standard (e.g., IEEE 802.11, Bluetooth, RFID, GSM, CDMA, et cetera) to produce inbound data 160. The processing performed by the receiver processing module 144 includes, but is not limited to, digital intermediate frequency to baseband conversion, demodulation, demapping, depuncturing, decoding, and/or descrambling. Note that the receiver processing modules 144 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 144 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

FIG. 6 is a schematic block diagram of an embodiment of an antenna interface in accordance with the present invention. In particular, the antenna interface 171 includes low noise amplifier 184, an impedance matching network 180 that provides impedance matching between the antenna and the low noise amplifier 184, and a bandpass filter 182 for filtering out-of-band signals from the inbound RF signal. In an embodiment of the present invention, the impedance matching network 180, can include a transformer, balun, pi-network, T-network, L-network or other circuit configuration. In addition, bandpass filter can be implemented with a tank circuit, transformer, crystal or with other circuit components. While shown as three separate modules 180, 182 and 184 two or more of these components can be implemented as part of a single circuit or design.

FIG. 7 is a schematic block diagram of another embodiment of an antenna interface in accordance with the present invention. In particular, this antenna interface 171 showns one possible implementation that a diplexer (duplexer) 185 for coupling the transmit signal 155 through bandpass filter 182 and impedance matching network 180 to the antenna, when in a transmit mode, to produce outbound RF signal 170, while isolating the transmit signal 155 from the low noise amplifier 184. Further inbound RF signal 152, as processed by impedance matching network 180 and bandpass filter 182 is coupled to the low noise amplifier 184, when in receive mode. As discussed in conjunction with FIG. 5, a transmit/receive switch could also be employed for this purpose.

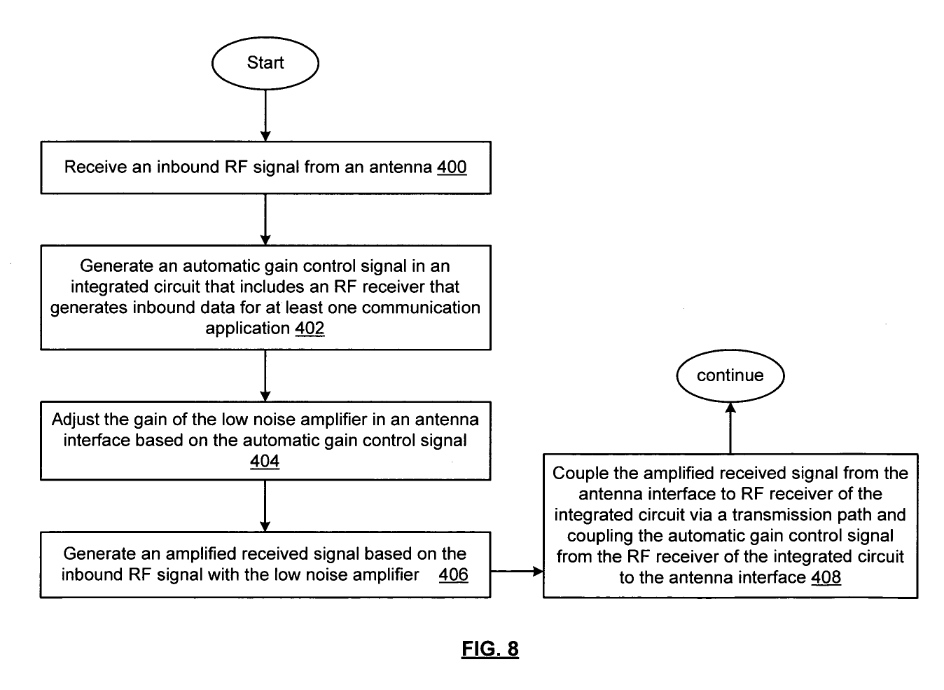

FIG. 8 is a flow chart of an embodiment of a method in accordance with the present invention. In particular, a method is presented for use in conjunction with one or more of the functions and features described in conjunction with FIGS. 1-7. In step 400, an inbound RF signal is received from an antenna. In step 402, an automatic gain control signal is received in an integrated circuit that includes an RF receiver that generates inbound data for at least one communication application, such as the applications discussed in conjunction with communication devices 10 and/or 30. In step 404, the gain of the low noise amplifier is adjusted in an antenna interface based on the automatic gain control signal. In step 406, an amplified received signal is generated based on the inbound RF signal with the low noise amplifier. In step 408, the amplified received signal is coupled from the antenna interface to RF receiver of the integrated circuit via a transmission path the automatic gain control signal is coupled from the RF receiver of the integrated circuit to the antenna interface.

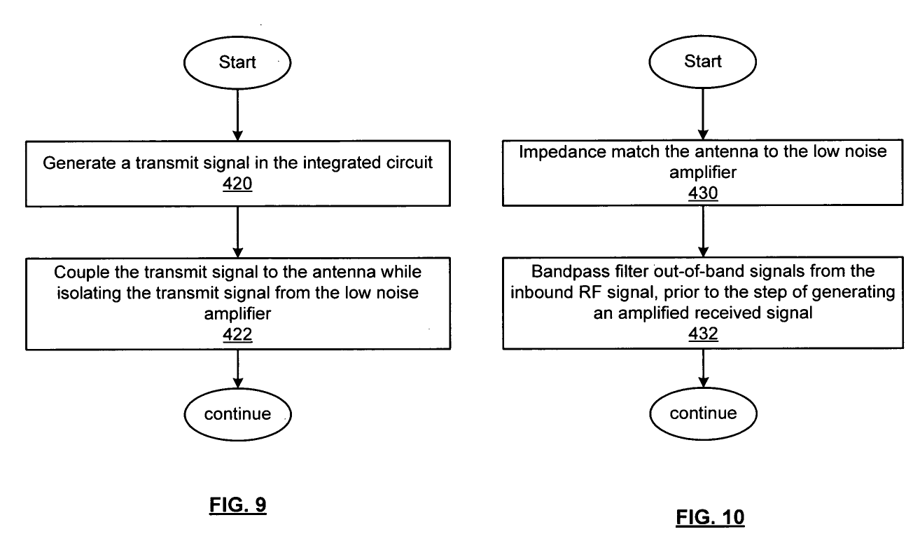

FIG. 9 is a flow chart of an embodiment of a method in accordance with the present invention. In particular, a method is presented for use in conjunction with the method described in conjunction with FIG. 8. In addition, the method includes step 420 of generating a transmit signal in the integrated circuit and step 422 of coupling the transmit signal to the antenna while isolating the transmit signal from the low noise amplifier.

FIG. 10 is a flow chart of an embodiment of a method in accordance with the present invention. In particular, a method is presented for use in conjunction with the method described in conjunction with FIG. 8. In addition, the method includes step 430 of impedance matching the antenna to the low noise amplifier, and step 432 of bandpass filtering out-of-band signals from the inbound RF signal, prior to the step of generating an amplified received signal.

FIG. 11 is a flow chart of an embodiment of a method in accordance with the present invention. In particular, a method is presented for use in conjunction with the method described in conjunction with FIG. 8. In addition, the method includes step 440 of coupling the automatic gain control signal to the low noise amplifier via the transmission path.

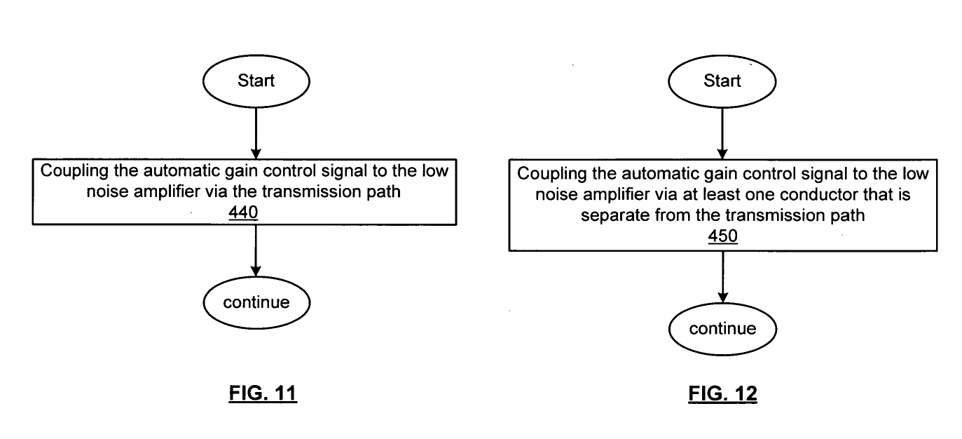

FIG. 12 is a flow chart of an embodiment of a method in accordance with the present invention. In particular, a method is presented for use in conjunction with the method described in conjunction with FIG. 8. In addition, the method includes step 450 of coupling the automatic gain control signal to the low noise amplifier via at least one conductor that is separate from the transmission path.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. An communication device comprising:
an antenna that receives and inbound RF signal;
an antenna interface, coupled to the antenna, that includes a low noise amplifier that generates an amplified received signal, based on the inbound RF signal, the low noise amplifier having a gain that is based an automatic gain control signal;
a transmission path coupled to the low noise amplifier that carries the amplified received signal;
a voice, data and RF integrated circuit, coupled to the transmission path, that includes a RF receiver with an RF front end that generates a desired RF signal from the amplified received signal, a down conversion module, that generates a down converted signal from the desired RF signal and a receiver processing module that generates inbound data for at least one communication application.

2. The communication device of claim 1 wherein the voice, data and RF integrated circuit further includes an RF transmitter, that generates a transmit signal, and wherein the antenna interface includes a diplexer for coupling the transmit signal to the antenna and isolating the transmit signal from the low noise amplifier.

3. The communication device of claim 1 wherein the antenna interface further includes and impedance matching network and a bandpass filter coupled between the antenna and the low noise amplifier, the impedance matching network providing impedance matching to the antenna and the bandpass filter filtering out-of-band signals from the inbound RF signal.

4. The communication device of claim 1 wherein the RF receiver generates the automatic gain control signal.

5. The communication device of claim 4 wherein the voice, data and RF integrated circuit couples the automatic gain control signal to the low noise amplifier via the transmission path.

6. The communication device of claim 4 wherein the integrated circuit couples the automatic gain control signal to the low noise amplifier via at least one conductor that is separate from the transmission path.

7. An communication device comprising:
an antenna that receives and inbound RF signal;
an antenna interface, coupled to the antenna, that includes a low noise amplifier that generates an amplified received signal, based on the inbound RF signal;
a transmission path coupled to the low noise amplifier that carries the amplified received signal;
an integrated circuit, coupled to the transmission path, that includes a RF receiver with an RF front end that generates a desired RF signal from the amplified received signal, a down conversion module, that generates a down converted signal from the desired RF signal and a receiver processing module that generates inbound data for at least one communication application.

8. The communication device of claim 7 wherein the integrated circuit further includes an RF transmitter, that generates a transmit signal, and wherein the antenna interface includes a diplexer for coupling the transmit signal to the antenna and isolating the transmit signal from the low noise amplifier.

9. The communication device of claim 7 wherein the antenna interface further includes and impedance matching network and a bandpass filter coupled between the antenna and the low noise amplifier, the impedance matching network providing impedance matching to the antenna and the bandpass filter filtering out-of-band signals from the inbound RF signal.

10. The communication device of claim 7 wherein the low noise amplifier has a gain that is based an automatic gain control signal the RF receiver generates the automatic gain control signal.

11. The communication device of claim 10 wherein the integrated circuit couples the automatic gain control signal to the low noise amplifier via the transmission path.

12. The communication device of claim 10 wherein the integrated circuit couples the automatic gain control signal to the low noise amplifier via at least one conductor that is separate from the transmission path.

13. A reception system comprising:
an antenna that receives and inbound RF signal;
an antenna interface, coupled to the antenna, that includes a low noise amplifier that generates an amplified received signal, based on the inbound RF signal;
a transmission path coupled to the low noise amplifier that carries the amplified received signal;
an integrated circuit, coupled to the transmission path, that includes a RF receiver with an RF front end that generates a desired RF signal from the amplified received signal, a down conversion module, that generates a down converted signal from the desired RF signal and a receiver processing module that generates inbound data for at least one communication application.

14. The communication device of claim 13 wherein the antenna interface further includes and impedance matching network and a bandpass filter coupled between the antenna and the low noise amplifier, the impedance matching network providing impedance matching to the antenna and the bandpass filter filtering out-of-band signals from the inbound RF signal.

15. The communication device of claim 13 wherein the low noise amplifier has a gain that is based an automatic gain control signal the RF receiver generates the automatic gain control signal.

16. The communication device of claim 15 wherein the integrated circuit couples the automatic gain control signal to the low noise amplifier via the transmission path.

17. The communication device of claim 15 wherein the integrated circuit couples the automatic gain control signal to the low noise amplifier via at least one conductor that is separate from the transmission path.

18. A method comprising:
receiving an inbound RF signal from an antenna;
generating an automatic gain control signal in an integrated circuit that includes an RF receiver that generates inbound data for at least one communication application;
adjusting the gain of the low noise amplifier in an antenna interface based on the automatic gain control signal;
generating an amplified received signal based on the inbound RF signal with the low noise amplifier; and
coupling the amplified received signal from the antenna interface to RF receiver of the integrated circuit via a transmission path and coupling the automatic gain control signal from the RF receiver of the integrated circuit to the antenna interface.

19. The method of claim 18 further comprising:
generating a transmit signal in the integrated circuit; and
coupling the transmit signal to the antenna while isolating the transmit signal from the low noise amplifier.

20. The method of claim 18 further comprising:
impedance matching the antenna to the low noise amplifier; and
bandpass filtering out-of-band signals from the inbound RF signal, prior to the step of generating an amplified received signal.

21. The method of claim 18 further comprising:
coupling the automatic gain control signal to the low noise amplifier via the transmission path.

22. The method of claim 18 further comprising:
coupling the automatic gain control signal to the low noise amplifier via at least one conductor that is separate from the transmission path.
